(19) United States
(12) Patent Application Publication
(10) Pub. No.: US 2026/0268707 A1
(43) Pub. Date: Sep. 10, 2026

(54) ONSCREEN TELEMETRY FOR FACIAL RECOGNITION

(71) Applicant: eConnect, Inc., Las Vegas, NV (US)

(72) Inventors: Jeremiah Morrill, Somers, MT (US); Travis Whidden, Las Vegas, NV (US)

(21) Appl. No.: 19/348,782

(22) Filed: Oct. 2, 2025

Related U.S. Application Data
(60) Provisional application No. 63/702,475, filed on Oct. 2, 2024.

(51) Int. Cl. G06V 40/16; G06F 21/32

(52) U.S. Cl. CPC G06V 40/172; G06F 21/32

(57) ABSTRACT

Technologies and implementations for facilitating real time telemetry for facial recognition. The technologies and implementation may include a facial recognition telemetry module (FRTM), where the FRTM may be configured to facilitate telemetry configured to follow a candidate of the facial recognition having various information associated with the candidate.

### CROSS REFERENCE TO RELATED APPLICATIONS

This application claims benefit of priority to U.S. Provisional Patent Application Ser. No. 63/702,475, filed on Oct. 2, 2024, titled ONSCREEN TELEMETRY FOR FACIAL RECOGNITION, which is incorporate herein by reference in its entirety for all purposes.

### BACKGROUND

Unless otherwise indicated herein, the approaches described in this section are not prior art to the claims in this application and are not admitted to be prior art by inclusion in this section.

Facial recognition systems may primarily focus on capturing and comparing facial features to facilitate verification of identity. While these methods may effectively register the anatomical structure of a face, they typically do not incorporate other details that may facilitate determination other information than facial recognition. Accordingly, there may be an oversight in incorporating non-facial contextual details such as, but not limited to, adjacent environmental cues, apparel characteristics, spatial posture information, and/or other variety of information. These additional details, although may not be inherently facial, may facilitate in providing invaluable context to improve recognition accuracy under challenging conditions, such as low resolution, occlusions, overlapping candidates, and so forth.

All subject matter discussed in this section of this document is not necessarily prior art and may not be presumed to be prior art simply because it is presented in this section. Plus, any reference to any prior art in this description is not and should not be taken as an acknowledgement or any form of suggestion that such prior art forms parts of the common general knowledge in any art in any country. Along these lines, any recognition of problems in the prior art are discussed in this section or associated with such subject matter should not be treated as prior art, unless expressly stated to be prior art. Rather, the discussion of any subject matter in this section should be treated as part of the approach taken towards the particular problem by the inventor(s). This approach in and of itself may also be inventive. Accordingly, the foregoing summary is illustrative only and not intended to be in any way limiting. In addition to the illustrative aspects, embodiments, and features described above, further aspects, embodiments, and features will become apparent by reference to the drawings and the following detailed description.

### SUMMARY

Described herein are various illustrative methods, systems, and apparatus for facilitating transient event ticket purchase utilizing biometric data.

Some example systems may include a processor, a storage medium, and a facial recognition telemetry module (FRTM). In one example, the FRTM may be configured to receive data representative of biometric data from an image capture device of a candidate. Responsive to the received data, the FRTM may be configured to search a database for candidate recognition based, at least in part, on the received biometric data. The FRTM may be configured to upon recognition of the candidate, search for data unrelated to the biometric data of the candidate. The FRTM may be configured to cause to display a telemetry, the telemetry having information associated with the recognition and data unrelated to the biometric data and to cause to display a leader to follow the candidate.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates a block diagram of system for facilitating real time telemetry for facial recognition, in accordance with various embodiments.

FIG. 2 illustrates detail of a real time telemetry for biometric recognition, in accordance with one or more embodiments.

FIG. 3 illustrates a real time telemetry for facial recognition for a person in a moving object, in accordance with one or more embodiments.

FIG. 4 illustrates an operational flow for facilitating real time telemetry for facial recognition, in accordance with at least some of the embodiments described herein.

FIG. 5 illustrates an example computer program product 500, arranged in accordance with at least some embodiments described herein.

FIG. 6 is a block diagram illustrating an example computing device 600, such as might be embodied by a person skilled in the art, which is arranged in accordance with at least some embodiments of the present disclosure.

### DETAILED DESCRIPTION

The following description sets forth various examples along with specific details to provide a thorough understanding of the claimed subject matter. It will be understood by those skilled in the art after review and understanding of the present disclosure, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, systems, and apparatus for real time telemetry for facial recognition. In the field of biometric identification and, more particularly, to the domain of facial recognition, the technological may be considered to be an important component of security, personal identification, user authentication systems, and so forth. Despite the ubiquitous integration of facial recognition technologies in various domains such as access control, law enforcement, and/or consumer electronics, a wide variety of detail about the candidate may not necessarily be included and/or displayed.

Facial recognition technology (FRT) may include basic image processing techniques to advanced artificial intelligence-driven systems. FRT may be utilized to help facilitate identification or verification of individuals by analyzing facial features, which may be extracted from digital images or video frames. The applications of FRT may span a wide variety of sectors such as, but not limited to, security, healthcare, retail, personal devices, etc. The potential for FRT to facilitate improvements in security, in enhancement of user experiences, providing personalized services, etc., may be considered to be high.

Some example approaches to FRT may include systems, which may include reliance on manual feature extraction and template matching. Variations in lighting, facial expressions, and/or angles may affect the accuracy of this type of approach.

Some other example approaches to FRT may include utilization of artificial intelligence (AI). One example of utilization of AI may involve a form of deep machine learning, which may facilitate improvements in accuracy and/or reliability. Deep machine learning may include approaches such as, but not limited to, convolutional neural networks (CNNs). For example, an example system may be configured to automatically extract complex features and/or may be configured to machine learn from large datasets. The utilization of deep machine learning may help to facilitate reducing affects such as, but not limited to, occlusions, different lighting conditions, changes in facial hair or accessories, and/or so forth.

Prior to turning to the figures, some non-limiting example scenarios may be described to more fully understand the claimed subject matter. For example, some non-limiting example scenarios illustrating the utilization and implementation of the various embodiments of the present disclosure may be described.

In one non-limiting example scenario, a space may include one or more image capturing devices (e.g., camera). The camera may be communicatively coupled with a machine, which may include among various components, a facial recognition telemetry module (FRTM). The FRTM may be communicatively coupled with a processor, where under the control of the processor, the FRTM may be configured to facilitate the various functionalities described herein. Additionally, the machine may be communicatively coupled with a network (e.g., internet) and a display.

In this example scenario, the space may be an outdoor space (e.g., square). A person may enter the square and may be captured by the camera (i.e., the person may be within the field of view of the camera). The image of the person may be transmitted to the FRTM, where under the control of the processor, the FRTM may determine the identity of the person.

Once the identity of the person is determined, the FRTM may search various databases for further information regarding the person. For example, the FRTM may find information regarding the person's physical attributes such as, but not limited to, the person's height, weight, eye color, etc. (physical info). The FRTM may cause the image of the person and the physical info to be displayed on a display, in accordance with various embodiments. The physical info may be displayed as part of an on-screen telemetry. For example, the FRTM may cause the physical info to be displayed as a bubble-like graphics. In addition to the physical info, the bubble-like graphics may include a variety of real-time information such as, but not limited to, the rate of travel of the person (e.g., pace of travel). Additionally, based at least in part on various accessible databases, the FRTM may find additional information such as, but not limited to, the person's personal information (e.g., medical history, social networking interactions, driver's license information, etc.). Some real-time information may include real-time physiological information such as, but not limited to, the person's heart rate, oximetry, etc. that may be available via various physiological tracking applications communicatively coupled to a network (e.g., via a communication type device such as, but not limited to, a smartphone). Any and/or all of the information that the FRTM may be configured/allowed to access may be displayed as part of the on-screen telemetry facilitating real-time information for the person in a variety of detail.

In another non-limiting example scenario, a camera may capture an image of a person operating a motor vehicle such as, but not limited to, a car. For example, the person may be driving the car along a road. A camera located some place with a view of the road may be configured to capture images of vehicles and/or their occupant(s). The FRTM may determine the identity of the person and may cause to display telemetry information, in accordance with various embodiments.

It should be appreciated that it is within the scope of the disclosure that the number of faces that may be recognized and have telemetry may be one or more (e.g., an individual and/or a crowd). Additionally, FRTM may cause facial recognition and telemetry information associated with any type of variety of activities involving the person(s).

In some examples, the various devices/machines may include machine learning capabilities such as, but not limited to, artificial intelligence (AI) capabilities that may be configured to utilize neural networks to facilitate the processing of real-time telemetry data including FRT and/or machine searching of databases. For example, it should be appreciated by one of ordinary skilled in the relevant art that the processor and/or processors described herein may include a wide variety of processors such as, but not limited to, processors capable of implementing machine learning/recognition/database searching methodologies including machine learning methodologies having AI capabilities to facilitate at least some of the functionality described herein. For example, AI capable processors may include processors such as, but not limited to, processors available from Intel Corporation of Santa Clara, California (e.g., Gaudi3 TM type processors), available from Nvidia Corporation of Santa Clara, California (e.g., H100 type processors), available from Apple Company of Cupertino, California (e.g., M3 type processors), available from Huawei Technologies Company of Shenzen, Guangdong, China (e.g., Ascend 910 type processors), available from Advanced Micro Devices, Inc. of Sunnyvale, California (e.g., MI300X type processors), available from Samsung of Seoul, South Korea (e.g., Exynos type processors), and so forth. Accordingly, the claimed subject matter is not limited in these respects. The utilization of machine learning may facilitate machine learning of processing and managing biometric data as described herein.

As a result, real time telemetry for facial recognition may be facilitated.

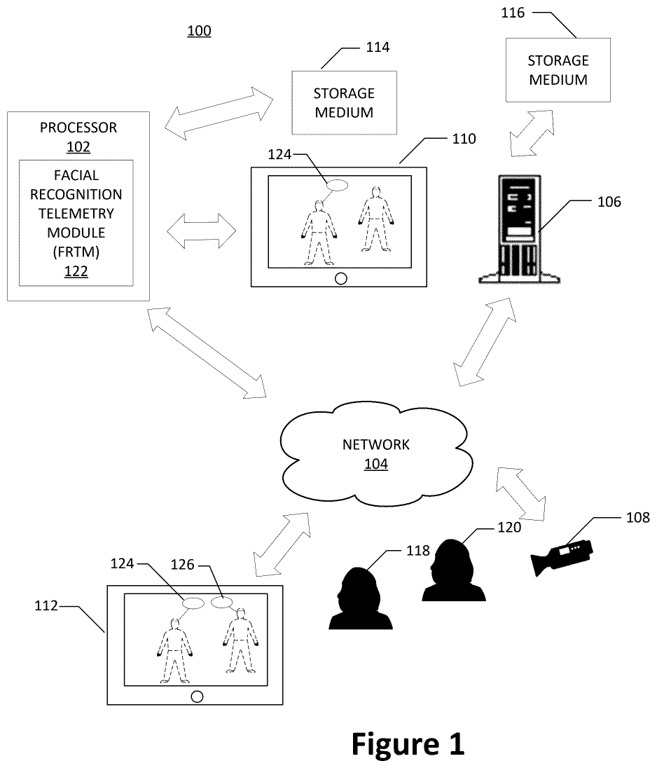

Turning now to FIG. 1, FIG. 1 illustrates a block diagram of system for facilitating real time telemetry for facial recognition, in accordance with various embodiments. In FIG. 1, a system 100 may include a processor 102, a network 104, a server 106, an image capture device (e.g., camera 108), a first display 110, a second display 112, a first storage medium 114, and a second storage medium 116. Additionally, the system 100 may include a first candidate 118 and a second candidate 120 (e.g., persons for biometric identification).

Shown in FIG. 1, the processor 102 may include a facial recognition telemetry module (FRTM 122). In the system 100, the processor 102 may be communicatively coupled to the first storage medium and to the first display 110. Additionally, the processor 102 may be communicatively coupled to the network 104. The server 106 may be communicatively coupled to the second storage medium 116, where the server 106 may be communicatively coupled to the network 104. The camera 108 may be communicatively coupled to the network 104, and the second display 112 may be communicatively coupled to the network 104 as well.

In FIG. 1, the camera 108 may capture an image of the first candidate 118 and the second candidate 120, which may be static images and/or video. For the purposes of describing the disclosure, the camera 108 may be configured to capture real-time video. In this example, the camera 108 may capture video of the first candidate 118 and the second candidate 120. The data representative of the real-time video of the first candidate 118 and the second candidate 120 may be received by the processor 102. Under the control of the processor 102, the FRTM 122 may be configured to cause to display the first candidate 118 and the second candidate 120 on the first display 110. As shown, the FRTM 122 may be configured to cause to display a first telemetry 124 associated with the first candidate 118, in accordance with one or more embodiments.

As will be described in further detail, the first telemetry 124 may include a variety of information regarding the first candidate 118, where the variety of information may have been stored in the first storage medium 114 and/or the second storage medium 116, both of which may be accessible by the FRTM 122 responsive to receiving the data from the camera 108. In another example shown in FIG. 1, the FRTM 122 may be configured to cause to display both, the first candidate 118 and the second candidate 120 on the second display 112, which may be co-located or remotely located with the processor 102. As shown, the FRTM 122 may be configured to cause to display a second telemetry 126 on the second display 112. The second telemetry 126 may display various information associated with the second candidate 118.

In the one or more embodiments shown in FIG. 1, the first candidate 116 and/or the second candidate 118 may be in motion, where the real-time video captured by the camera 108 may include motion. The first telemetry 124 and the second telemetry 126 may be configured to associate with the first candidate 116 and the second candidate 118 respectively as the first candidate 116 and/or the second candidate 118 move and may be in motion. As a result, the system 100 may facilitate real time telemetry for facial recognition.

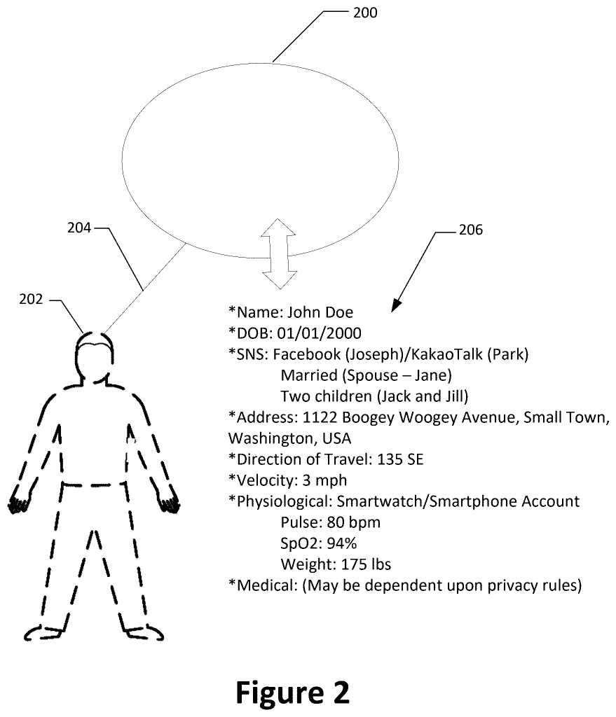

FIG. 2 illustrates detail of a real time telemetry for biometric recognition, in accordance with one or more embodiments. In FIG. 2, a telemetry 200 may be displayed as being associated with a candidate (e.g., person 202). As previously described, an FRTM (shown in FIG. 1) may be configured to cause to display the telemetry 200. The telemetry 200 may include a leader 204 that may be shown as coupled to the person 202, where the leader 204 may be configured to move with the person 202 to facilitate a continuous association of the telemetry 200 (i.e., the information that may be included the telemetry bubble).

As shown in FIG. 2, the telemetry 200 may include a variety of information 206 associated with the person 202 such as, but not limited to, name, date of birth, social networking service, address, movement of the person 202 (e.g., direction of travel), rate of travel (e.g., velocity), some form of physiological via some form smartwatch/ring/necklace, etc. (e.g., pulse, weight, peripheral capillary oxygen saturation, insulin level, electrocardiogram information, and so forth), and/or medical information (e.g., diabetic, blood pressure, cholesterol, cancer diagnosis including treatment-current/past). It should be appreciated that the availability of the information may be based, at least in part on, some privacy rules such as, but not limited to, HIPAA, COPPA, GDPR, CPRA, and so forth. As a result, the FRTM may facilitate real time telemetry for facial recognition of a person 202 including a variety of information of the person 202 as the person 202 moves around (e.g., alone and/or in a crowd). It should be appreciated that the image of the person 202 may be a still photograph as well. Accordingly, the claimed subject matter is not limited in this respect.

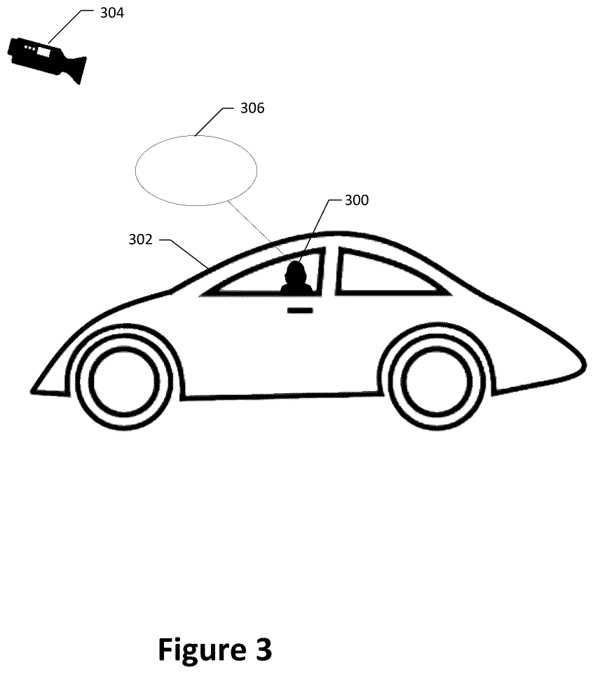

FIG. 3 illustrates a real time telemetry for facial recognition for a person in a moving object, in accordance with one or more embodiments. In FIG. 3, a candidate (e.g., person 300) may be riding in a vehicle 302. As shown in FIG. 3, an image capture device (e.g., camera 304) may capture the person 300 traveling within the vehicle 302. Responsive to receiving the data representative of the person 300 traveling within the vehicle 302, an FRTM (shown in FIG. 1) may be configured to perform a biometric recognition upon the person 300 and may cause to display additional information related to the person 300 as a telemetry 306. The telemetry 304 may include a wide variety of information that the FRTM may be provided access (e.g., various servers and/or databases). The camera 304 may be one of several cameras that may be disposed along a road. As a result, the FRTM may facilitate real time telemetry for facial recognition a person 300 including a variety of information of the person 300 as the person 300 may be traveling at relatively high speeds in a vehicle 302. For example, a series of traffic cameras that may be utilized with one or more embodiments.

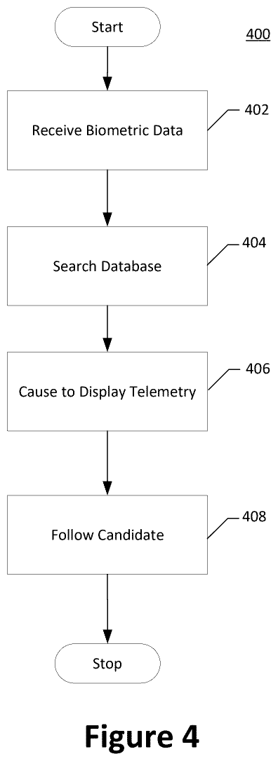

FIG. 4 illustrates an operational flow for facilitating real time telemetry for facial recognition, in accordance with at least some of the embodiments described herein. In some portions of the description, illustrative implementations of the method are described with reference to the system 100 depicted in FIG. 1. However, the described embodiments are not limited to these depictions. More specifically, some elements depicted in FIG. 1 may be omitted from some implementations of the methods detailed herein. Furthermore, other elements not depicted in FIG. 1 may be used to implement example methods detailed herein.

Additionally, FIG. 4 may employ block diagrams to illustrate the example methods detailed therein. These block diagrams may set out various functional blocks or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in the figures may be eliminated. In some examples, the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of claimed subject matter.

In some examples, operational flow 400 may be employed as part of a real time telemetry for facial recognition utilizing biometric platform including displaying various information that may not be biometric. Beginning at block 402 (“Receive Biometric Data”), the FRTM 122 may receive data representative of biometric data (e.g., facial data) from an image capture device.

Continuing from block 402 to 404 (“Search Database”), responsive to receiving the biometric data from the image capture device, the FRTM 122 may search one or more databases for facial recognition including various data associated with the facial recognition (e.g., various data associated with the recognized face).

Continuing from block 404 to 406 (“Cause to Display Telemetry”), the FRTM 122 may cause to display a telemetry coupled with the identified person, where the telemetry may include a wide variety of information associated with the person that may or may not be biometric information.

Continuing from block 406 to 408 (“Follow Candidate”), the FRTM 122 may cause to display a leader, which may be utilized to follow the person/candidate as they move about.

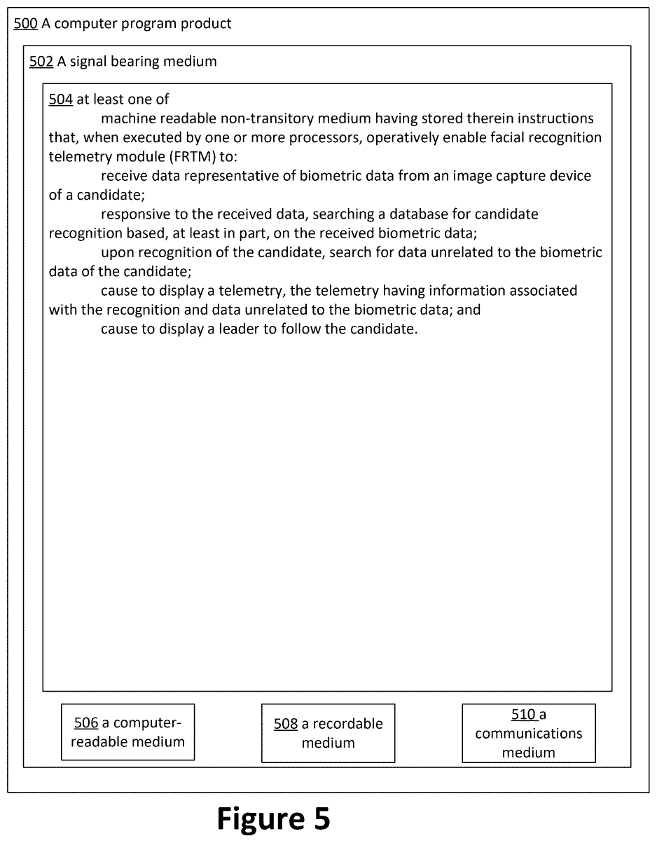

In general, the operational flow described with respect to FIG. 4 and elsewhere herein may be implemented as a computer program product, executable on any suitable computing system, or the like. For example, a computer program product for facilitating real time telemetry for facial recognition may be provided. Example computer program products are described with respect to FIG. 5 and elsewhere herein.

FIG. 5 illustrates an example computer program product 500, arranged in accordance with at least some embodiments described herein. Computer program product 500 may include machine readable non-transitory medium having stored therein instructions that, when executed, cause the machine to facilitate real time telemetry for facial recognition according to the processes and methods discussed herein. Computer program product 500 may include a signal bearing medium 502. Signal bearing medium 502 may include one or more machine-readable instructions 504, which, when executed by one or more processors, may operatively enable a computing device to provide the functionality described herein. In various examples, some or all of the machine-readable instructions may be used by the devices discussed herein.

In some examples, the machine readable instructions 504 may include instruction to receive data representative of biometric data from an image capture device of a candidate. The machine readable instructions 504 may include responsive to the received data, searching a database for candidate recognition based, at least in part, on the received biometric data. The machine readable instructions 504 may include upon recognition of the candidate, search for data unrelated to the biometric data of the candidate. The machine readable instruction 504 may include cause to display a telemetry, the telemetry having information associated with the recognition and data unrelated to the biometric data. The machine readable instruction 504 may include cause to display a leader to follow the candidate.

In some implementations, signal bearing medium 502 may encompass a computer-readable medium 506, such as, but not limited to, a hard disk drive, a Compact Disc (CD), a Digital Versatile Disk (DVD), a digital tape, memory, etc. In some implementations, the signal bearing medium 502 may encompass a recordable medium 508, such as, but not limited to, memory, read/write (R/W) CDs, R/W DVDs, etc. In some implementations, the signal bearing medium 502 may encompass a communications medium 510, such as, but not limited to, a digital and/or an analog communication medium (e.g., a fiber optic cable, a waveguide, a wired communication link, a wireless communication link, etc.). In some examples, the signal bearing medium 502 may encompass a machine readable non-transitory medium.

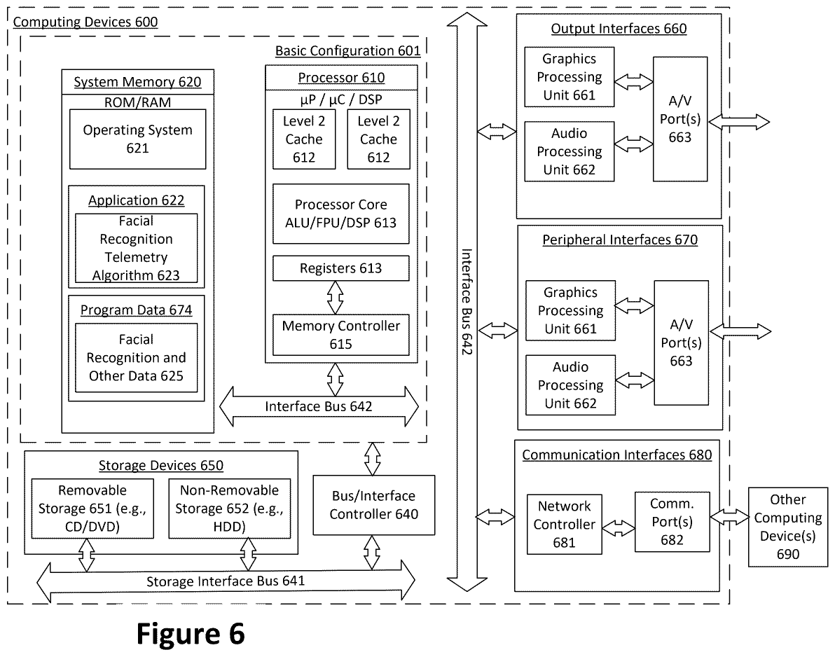

In general, the methods described with respect to FIG. 4 and elsewhere herein may be implemented in any suitable computing system. Example systems may be described with respect to FIG. 6 and elsewhere herein. In general, the system may be configured to facilitate real time telemetry for facial recognition.

FIG. 6 is a block diagram illustrating an example computing device 600, such as might be embodied by a person skilled in the art, which is arranged in accordance with at least some embodiments of the present disclosure. In one example configuration 601, computing device 600 may include one or more processors 610 and system memory 620. A memory bus 630 may be used for communicating between the processor 610 and the system memory 620.

Depending on the desired configuration, processor 510 may be of any type including but not limited to a microprocessor (μP), a microcontroller (μC), a digital signal processor (DSP), a graphics processing unit (GPU), a processing unit utilizing reduced instruction set computer (RISC) architecture, and/or any combination thereof. Processor 610 may include one or more levels of caching, such as a level one cache 611 and a level two cache 612, a processor core 613, and registers 614. The processor core 613 may include an arithmetic logic unit (ALU), a floating point unit (FPU), a digital signal processing core (DSP Core), or any combination thereof. A memory controller 615 may also be used with the processor 610, or in some implementations the memory controller 615 may be an internal part of the processor 610.

Depending on the desired configuration, the system memory 620 may be of any type including but not limited to volatile memory (such as RAM), non-volatile memory (such as ROM, flash memory, etc.) or any combination thereof. System memory 620 may include an operating system 621, one or more applications 622, and program data 624. Application 622 may include facial recognition telemetry module (FRTM) algorithm 623 that is arranged to perform the functions as described herein including the functional blocks and/or actions described. Program Data 624 may include types of facial recognition and other data 625 for use with FRTM 623. In some example embodiments, application 622 may be arranged to operate with program data 624 on an operating system 621 such that implementations of facilitating FRTM 623 configured to machine learn facial recognition and other data for display as telemetry information as described herein. For example, apparatus described in the present disclosure may comprise all or a portion of computing device 600 and be capable of performing all or a portion of application 622 such that implementations of facilitating communication module configured to determine biometric matching may be provided as described herein. This described basic configuration is illustrated in FIG. 5 by those components within dashed line 601.

Computing device 600 may have additional features or functionality, and additional interfaces to facilitate communications between the basic configuration 601 and any required devices and interfaces. For example, a bus/interface controller 640 may be used to facilitate communications between the basic configuration 601 and one or more data storage devices 650 via a storage interface bus 641. The data storage devices 650 may be removable storage devices 651, non-removable storage devices 652, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable, and non-removable media implemented in any method or technology for storage of information, such as computer readable instructions, data structures, program modules, or other data.

System memory 620, removable storage 651 and non-removable storage 652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of device 600.

Computing device 600 may also include an interface bus 642 for facilitating communication from various interface devices (e.g., output interfaces, peripheral interfaces, and communication interfaces) to the basic configuration 601 via the bus/interface controller 640. Example output interfaces 660 may include a graphics processing unit 661 and an audio processing unit 662, which may be configured to communicate to various external devices such as a display or speakers via one or more A/V ports 663. Example peripheral interfaces 660 may include a serial interface controller 671 or a parallel interface controller 672, which may be configured to communicate with external devices such as input devices (e.g., keyboard, mouse, pen, voice input device, touch input device, etc.) or other peripheral devices (e.g., printer, scanner, etc.) via one or more I/O ports 673. An example communication interface 680 includes a network controller 681, which may be arranged to facilitate communications with one or more other computing devices 690 over a network communication via one or more communication ports 682. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 600 may also be implemented as a personal computer including both laptop computer and non-laptop computer configurations. In addition, computing device 600 may be implemented as part of a wireless base station or other wireless system or device.

It should be appreciated after review of this disclosure that it is contemplated within the scope and spirit of the present disclosure that the claimed subject matter may include a wide variety of routers, modems, computing devices, communication mediums/approaches, etc. Accordingly, the claimed subject matter is not limited in these respects.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter is not limited to the particular examples disclosed, but that such claimed subject matter also may include all implementations falling within the scope of the appended claims, and equivalents thereof.

1. A method in a computer environment, the method comprising:
receiving data representative of biometric data from an image capture device of a candidate;
responsive to the received data, search a database for candidate recognition based, at least in part, on the received biometric data;
upon recognition of the candidate, search for data unrelated to the biometric data of the candidate;
cause to display a telemetry, the telemetry having information associated with the recognition and data unrelated to the biometric data; and
cause to display a leader to follow the candidate.
